(19) United States
(12) Patent Application Publication
(10) Pub. No.: US 2018/0109491 A1
(43) Pub. Date: Apr. 19, 2018

(54) NON-ELECTRONIC FIREWALL SYSTEM

(71) Applicants: Zoltan G. Szinte, Hartland, WI (US); Peter G. Szinte, Hartland, WI (US)

(72) Inventors: Zoltan G. Szinte, Hartland, WI (US); Peter G. Szinte, Hartland, WI (US)

(21) Appl. No.: 15/294,687

(22) Filed: Oct. 15, 2016

(51) Int. Cl. H04L 29/06; H04N 5/247; H04N 1/00; G06F 21/60

(52) U.S. Cl. CPC H04L 63/0209; G06F 21/606; H04N 1/00018; H04N 5/247

(57) ABSTRACT

A non-electronic firewall system may include a first computer isolated from any network, a second computer connected to a network, a display connected to the second computer to display a first image from the second computer, and an image capture device connected to the first computer to capture a second image of a presentation of the display including the first image through a gap. A nonelectric firewall system may additionally or alternatively include a first computer isolated from any network, a second computer connected to a network, a display connected to the first computer to display a first image from the first computer and an image capture device connected to the second computer to capture an image of a presentation on the display including the first image through a gap and to transmit the first image across the network.

### BACKGROUND

Computers often contain or store extremely confidential information. Even with electronic firewalls, such computers may be susceptible to security breaches, malware and viruses, putting the computer and such confidential information at risk.

### BRIEF DESCRIPTION OF THE DRAWINGS

FIG. 1 is a schematic diagram of an example non-electronic firewall system.

FIG. 2 is a schematic diagram of an example non-electronic firewall system.

FIG. 3 is a schematic diagram of an example non-electronic firewall system.

FIG. 4 is a schematic diagram of an example non-electronic firewall system.

FIG. 5 is a schematic diagram of an example non-electronic firewall system.

FIG. 6 is a schematic diagram of an example non-electronic firewall system.

### DETAILED DESCRIPTION OF EXAMPLES

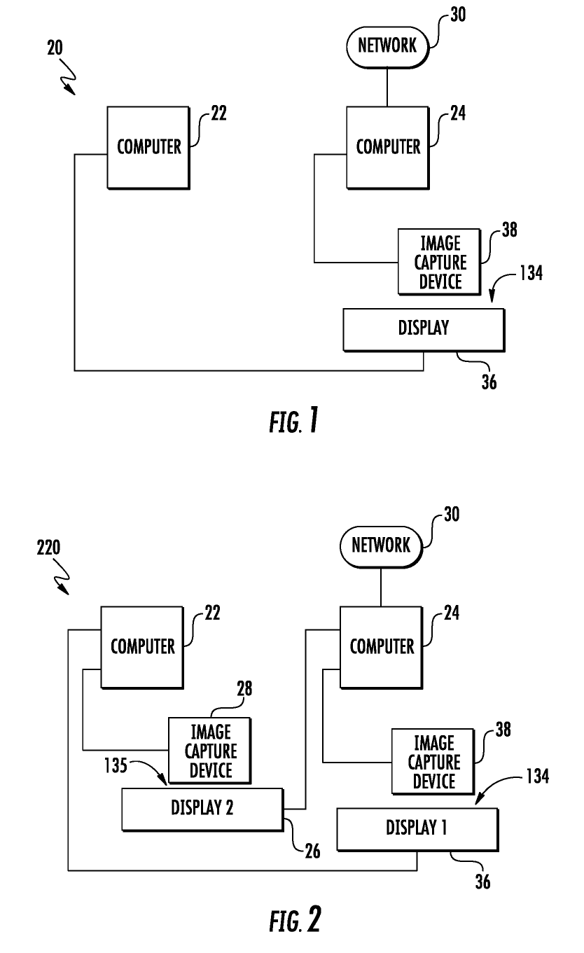

FIG. 1 schematically illustrates an example non-electronic firewall system 20. System 20 facilitates the transmission of data from a computer across a network without subjecting other data on the same computer to security risks. In other words, system 20 allows a user to draft an email, communication or other document on a computer and send the email, communication other document across the network without exposing the computer to viruses and malware and without exposing other data on the same computer to security and confidentiality breaches. System 20 comprises computer 22, computer 24, display 36 and image capture device 38.

Computer 22 comprises a computing device, such as a desktop, laptop or other computer. Computer 22 comprises a processor and a memory for storing data. Computer 22 is isolated from any network. In other words, computer 22 is not connected to a local area network or a wide area network in a wired or a wireless fashion. For example, in one implementation, computer 22 is not connected to any router or modem directly or indirectly. As a result, computer 22 cannot be infected with malware or viruses received from across a network. At the same time, however, computer 22 transmits information or data across the network through such a network connection.

Computer 24 is similar to computer 22 in that computer 24 comprises a processor and a memory. Computer 24 may additionally be associated with a dedicated display. In one implementation, computer 24 comprises a desktop computer. In another implementation, computer 24 comprises a laptop or notebook computer. In still other implementations, computer 24 may comprise a computing device such as a smart phone or personal data assistant. What distinguishes computer 24 from computer 22 is a computer 24 is connected to a network 30. In one implementation, computer 24 is connected to a router in a wired or wireless fashion. In another implementation, computer 24 is directly connected to a modem. Computer 24 is able to receive data or other information from sources across network 30. In one implementation, network 30 comprises a local area network. In another implementation, network 30 comprises a wide area network, such as the Internet.

Display 36 is connected to computer 22 in a wired fashion. Display 36 displays a digital image generated by computer 22. In particular, computer 22 comprises an application and appropriate drivers that cause display 36 to present a digital image for viewing. In one implementation, the digital image may be that of a document, spreadsheet, email or photo image generated or residing on computer 22.

Image capture device 38 is similar to image capture device 28 described above except that image capture device 38 captures a presentation of display 36 and is connected in a wired or wireless fashion to computer 24. In one implementation, display 36 and image capture device 38 are horizontally positioned relative to one another, wherein one of display 36 and device 38 rests upon the other of display 36 and device 38. In such an implementation, display 36 and image capture device 38 are separable from one another, allowing display 36 and image capture device 38 to be utilized for other independent purposes. In yet another implementation, display 36 and image capture device 38 may be part of a single unit contained within a single enclosure housing, wherein display 36 and image capture device 38 are fixed and retained relative to one another, ensuring proper alignment of any presentations on display 36 with image capture device 38.

In operation, in response to a user input command from a user interface, such as a keyboard, a microphone with speech recognition software or a touchscreen, computer 22, and more specifically, application of drivers on computer 22, computer 22 generates and displays a first digital image of the data using display 36.

In response to receiving a command to transmit the data ultimately received from computer 22, computer 24 outputs signals directing image capture device 38 to capture or generate a second image of the presentation of the display 36 which includes the first digital image. The captured image transmitted to the recipient across network 30. In one implementation, a user may provide computer 24 with the address of the recipient via the user interface. In other implementations, computer 24 may comprise optical character recognition software or programs that discern the address of the recipient contained in the digital image captured by image capture device 38. For example, optical character recognition software may be used to identify the format of a captured image as being that of an email and to identify an address in the format of the email. This address may then be extracted and utilized to automatically transmit the captured digital image across network 30.

In some implementations, computer 24 may comprise programs or applications that perform optical character recognition or other facial recognition software, wherein computer 24 additionally or alternatively converts the captured digital second image into a desired and possibly more editable or modifiable format. For example, in some implementations, computer 24 may receive an image captured by device 38 in a .tif or .jpg format. Computer 24 may include programs or applications that analyze the digital image to particular format of the original document. For example, computer 24 may identify the .tif or .jpg digital image as being an image of a WORD ^{TM} document (.doc). Such software may automatically convert the .tif or .jpg digital image to a corresponding WORD document, wherein the “translated” or converted document, the WORD document, is transmitted to the recipient across network 30 by computer 24. In such an implementation, the recipient may receive the data or information in the exact same format as was originally created by the personal computer 22 despite the fact that during the transmission process, the data in the original format (.doc, .pdf etc) was first converted to a different format, the format of an image file presented on display 36, which was captured as possibly another different formatted image file by image capture device 38, before being converted back to the original format.

As shown by FIG. 1, system 120 comprises a physical and electronic gap 134 between display 36 and image capture device 38. In other words, display 36 and image capture device 38 are not electrically connected to one another in a fashion so as to be able to transmit signals therebetween that specifically correspond to data. This break or gap 134 serves as a barrier to hackers and others who might otherwise attempt to improperly access data on computer 22 across a network, such as network 30. As a result, system 120 allows a person to transmit data across a network without subjecting the originating computer 22 to malware, viruses and the like and without subjecting the data already on the computer 22 to security risks.

FIG. 2 schematically illustrates non-electronic firewall system 220. System 220 is similar to system 20 described above except that system 220 additionally comprises display 26 and image capture device 28. Those remaining components of system 220 which correspond to components of system 20 are numbered similarly. Non-electronic firewall system 220 additionally provides computer 22 with the ability to store data and information that has been transmitted across the network 30 without a direct network connection to computer 22.

Display 26 is connected to computer 24, in a wired or wireless fashion, to display a digital image transmitted from computer 24. Display 26, under the control of drivers and applications on computer 24, may present data or information that has been acquired from across network 30. Such data may be presented in the form of a digital image. In one implementation, display 26 comprises a flat screen display. In one implementation, display 26 comprises a flatbed display, a display that rests on a substantially horizontal surface and faces in an upward direction. In one implementation, display 26 has dimensions of at least 8.5″×11″, corresponding to the standard letter-size of paper. In another implementation, display 26 may comprise the display of a smart phone, tablet computer or portable data assistant.

Image capture device 28 comprise a device connected to computer 22, in a wired fashion, to capture a second image of a presentation of the display 26 which includes the first image. Image capture device 28 generates a digital image of a presentation on display 26 of a digital image that was generated by computer 24. In one implementation, image capture device 28 comprises a camera appropriately focused so as to capture the entire presentation of the first image on display 26. In another implementation, image capture device 20 comprises a scanning device or scanner, a device that scans or moves a scanning bar across an area to be digitally captured. For example, in one implementation, image capture device 28 may comprise a flatbed scanner.

In one implementation, display 26 and image capture device 28 are horizontally positioned relative to one another, wherein one of display 26 and device 28 rests upon the other of display 26 and device 28. In such an implementation, display 26 and image capture device 28 are separable from one another, allowing display 26 and image capture device 28 to be utilized for other independent purposes. In yet another implementation, display 26 and image capture device 28 may be part of a single unit contained within a single enclosure housing, wherein display 26 and image capture device 28 are fixed and retained relative to one another, ensuring proper alignment of any presentations on display 26 with image capture device 28.

In one implementation, display 26 does not have any computing capabilities other than the presentation of images under the control of computer 24. In another implementation, display 26 may itself be a computing device connected to network 30. For example, display 26 may be provided as part of a portable electronic device, such as smart phone, which is independently connectable to network 30, but which may receive images for display from computer 24. In yet other implementations, computer 24 and display 26 may be embodied as a single portable electronic device, such as a smart phone or tablet computer.

In operation, computer 24 receives or retrieves data or information from a source across network 30. This data may be permanently or temporarily stored in the memory of computer 24. In response to a user input command from a user interface, such as a keyboard, a microphone with speech recognition software or a touchscreen, computer 24, and more specifically, application of drivers on computer 24, may cause display 26 to present a digital image of the data that was received across network 30.

In response to receiving command to store the data that was received from a source across the network, computer 22 outputs signals directing image capture device 28 to capture or generate a second image of the presentation of the display 26 which includes the first digital image. The captured image is then stored in the memory of computer 22.

In some implementations, computer 22 may comprise programs or applications that perform optical character recognition or other facial recognition software, wherein computer 22 additionally or alternatively converts the captured digital second image into a desired and possibly more editable or modifiable format. For example, in some implementations, computer 24 may receive a WORD™ document (.doc) from a source across network 30. The WORD document is then presented on display 26. Image capture device 28 generates a digital image file such as a tif or jpeg file of the data that is presented in the original WORD document. The optical character recognition software may identify the format as being a WORD document format and automatically produce and store on computer 22 a second WORD document matching or substantially matching the original WORD document that was displayed on display 26 by computer 24.

As shown by FIG. 2, system 20 comprises a physical gap 135 between display 26 and image capture device 28. In other words, display 26 and image capture device 28 are not electrically connected to one another in a fashion so as to be able to transmit signals therebetween that specifically correspond to data. This break or gap 135 serves as a barrier to hackers and others who might otherwise attempt to improperly access data on computer 22 across a network, such as network 30. As a result, system 20 allows a person to retrieve and store data from across a network on a computer without subjecting data already on the computer to security risks. System 220 protects computer 22 from malware, viruses and data security breaches while at the same time allowing computer 22 to receive data from sources across network 30 and to transmit data to recipients across network 30.

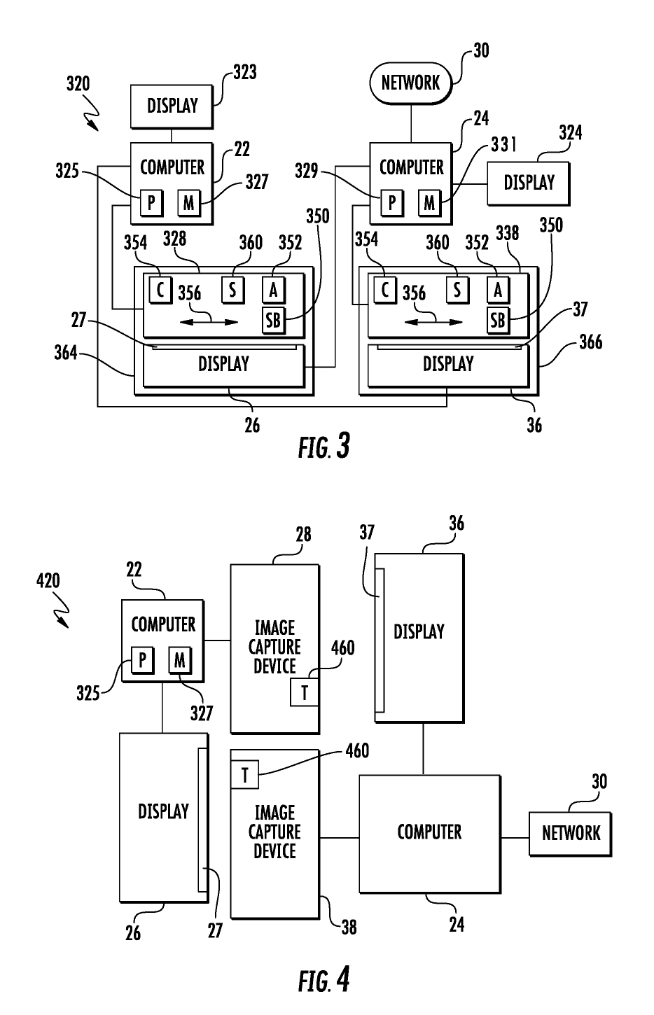

FIG. 3 schematically illustrates an example non-electronic firewall system 320. System 320 is similar to system 220 described above except that system 320 is illustrated as specifically comprising display 323, display 324, and image capture devices 328 and 338. As further shown by FIG. 3, computer 22 specifically comprises processor 325 and an associated memory 327. Likewise, computer 24 specifically comprises processor 329 and non-transitory memory 331.

Processors 325 and 329 each comprises a processing unit to carry out instructions contained in memories 327 and 331. For purposes of this application, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, processors 325 and 329 may be embodied as part of one or more application-specific integrated circuits (ASICs). Unless otherwise specifically noted, the controller is not limited to any specific combination of hardware circuitry and software, nor to any particular source for the instructions executed by the processing unit.

Displays 323 and 324 comprise devices that directly present information from computer 22 and 24, respectively, for viewing by the respective users. Displays 323, 324 may comprise desktop monitors, where computers 22 and 24 comprise desktop computers, may comprise display panels, such as where computers 22 and 24 comprise laptop or notebook computers or may comprise display screens incorporated as part of a body of a device, such as a tablet computer, that encloses both the display and the computer portion of the device.

Image capture devices 328 and 338 are similar to one another. Each of image capture device 328, 330 comprises a scanner sized and shaped to face their respective displays 26 and 36. As schematically shown by FIG. 3, each of image capture devices 328, 338 comprises a scanner bar 350, and actuator 352 and a controller 354. Scanner bar 350 captures portions of the presentation of display 26, 36 as scanner bar 350 is translated (as indicated by arrows 356) across the presentation of display 26 by actuator 352, which may comprise a motor, electric solenoid or the like. Controller 354 controls the driving scanner bar 350 and the generation of electric signals representing the captured image of the presentation of display 26. Such signals are transmitted to the respective computers 22 and 24 by image capture devices 328, 338. In the example illustrated, image capture devices 328 and 338 physically rest upon the respective displays 26 and 36. In one implementation, image capture devices 328 and 338 mate or seal with displays 26 and 36 to inhibit the ingress of light contamination. In another implementation, image capture devices 328 and 338 underlie the respective displays 26 and 36.

As further shown by FIG. 3, in one particular embodiment, each of image capture devices 328 and 338 additionally comprises a sensor 360. Sensor 360 senses the presence of a presentation of an image on the respective display 26, 36. In one implementation, each of sensors 360 comprises an optical sensor that senses changes in the light being output by display 26, 36 when an image is being presented on display 26, 36. In such an implementation, controller 354 automatically activates its respective image capture device 328, 338 to begin the capture of an image in response to the sensed presence of an image on the respective display 26, 36. For example, in response to determining that an image is being presented on display 26, controller 354 automatically activates image capture device 328, and automatically initiating the capture of an image for subsequent transmission to computer 22. Controller 354 of image capture device 338 may operate in a similar fashion. In yet other implementations, signals from sensors 360 are transmitted to the respective computer 22, 24, wherein the respective computer 22, 24 automatically activate the respective connected image capture devices 328, 338 to initiate scanning or the capture of the image being presented on the respective display 26, 36. In yet other implementations, sensor 360 may be omitted. In still other implementations, image capture devices 328, 338 may comprise other forms of image capture devices, such as cameras, which are automatically triggered to initiate image capture in response to signals from sensors 360.

As indicated by broken lines, in one implementation, display 26 and image capture device 328 may be enclosed within a single housing or body as a single unit 364. In one implementation, the single housing or body fixes display 26 and image capture device 28 relative to one another to ensure their proper alignment and focusing distance. In another implementation, the single housing or body allows display 26 and/or image capture device 328 to be removed as a module for independent use. For example, single body your housing may include drawers or slots into which display 26 and/or image capture device 328 may be removably positioned. In such an implementation, the single unit 364 provides a single electronic device that may be simply plugged into computers 22 and 24 for providing non-electronic firewall system 20 described above. In such an implementation, the single unit 364 may comprise an image capture device 28 other than image capture device 328.

Similarly, as indicated by broken lines, in one implementation, display 36 and image capture device 338 may be enclosed within a single housing or body as a single unit 366. In one implementation, the single housing or body fixes display 36 and image capture device 338 relative to one another to ensure their proper alignment and focusing distance. In another implementation, the single housing or body allows display 36 and/or image capture device 338 to be removed as a module for independent use. For example, single body or housing may include drawers or slots into which display 36 and/or image capture device 338 may be removably positioned. In such an implementation, the single unit 366 provides a single electronic device that may be simply plugged into computers 22 and 24 for providing non-electronic firewall system 120 described above. In such an implementation, the single unit 364 may comprise an image capture device 38 other than image capture device 338. Thus, the simple addition of the units or modules 364, 366 allow two computers, one connected to the Internet and one isolated from the Internet, to provide data security.

FIG. 4 schematically illustrates non-electronic firewall system 420. System 420. System 420 is similar to system 220 except that system 420 specifically illustrates image capture devices 28 and 38 as additionally comprising image capture triggers 460 and being supported any vertical orientation opposite to the display screens 27, 37 of displays 26, 36 which are also supported in a vertical orientation. Triggers 460 of image capture devices 28, 38 detect or sense the presentation of an image by the respective displays 26, 36. In one implementation, triggers 460 comprise optical sensors. In another implementation, triggers 460 may comprise mechanical switches that automatically initiate image capture by the respective image capturing devices 28, 38 when the respective displays 26, 36 are positioned against or in contact with image capture device 28 and 38, respectively. For example, a user may initiate the presentation of an image on either of display 26 or display 36. Thereafter, the image capture device 28 may be positioned against display 36 or image capture device 38 may be positioned against display 26. Such adjacent positioning, stacking physical alignment may result in a button or other switch being pressed which triggers or initiates image capture.

FIG. 5 schematically illustrates non-electronic firewall system 520. System 520 comprises computer 22, display 323, image capture device 28 and portable device holder 550. Computer 22, display 323, and image capture device 28 are described above.

Portable device holder 550 comprises a device configured to hold and position a portable electronic device with respect to image capture device 28, correctly aligning and spacing a display of the portable electronic device with respect to image capture device 28. Examples of such a portable electronic device include, but are not limited to, a tablet computer, a personal data assistant or a smart phone, each of which is connected to network 30 in a wired or wireless fashion. FIG. 5 illustrates portable device holder 550 holding and retaining a portable electronic device 560 having a display 562 and connected to network 30.

In the example illustrated, portable device holder 550 comprises one or more datum surfaces 564 that precisely locate and space the display 562 of device 560 with respect to the image capturing elements of image capture device 28. In one implementation, portable device holder 550 comprises a platform 566 providing such datum surfaces. In other implementations, portable device holder 550 may comprise other tabs, projections or specifically shaped recesses that receive and key or mate with the outer profile of portable device 562 aligning position holding device 560 with respect to image capture device 28.

In the example illustrated, portable device holder 550 further comprises trigger 570. Trigger 570 comprises a device to sense or detect the positioning of device 560 in or on portable device holder 550. In response to detecting the presence of electronic device 560, trigger 570 output signals which are transmitted in a wired or wireless fashion to image capture device 28, automatically causing image capture device 28 to initiate the scanning or other image capture of the image being presented by display 562 of device 560. In one implementation, trigger 570 comprises a mechanical button or switch is pressed of under the weight of portable electronic device 560. In another implementation, trigger 570 may comprise an optical sensor which senses the presence of device 560 on platform 566 or otherwise within holder 550. In yet other implementations, trigger 570 may comprise other present sensing technologies or may be omitted.

System 520 allows a user to simply position his or her portable electronic device, tablet computer, smart phone or the like, within holder 550 when data acquired by portable device 550 across network 30 is to be captured and stored on computer 22 without exposing computer 22 two malware, viruses or data security breaches. In implementations were trigger 570 utilized, such data capture is automatically carried out and we by inserting device 560 into or onto holder 550. In other implementations, data capture may be in response to manual input commands to computer 22 or image capture device 28. As indicated by broken lines, in some implementations, image capture device 28 and portable device holder 550 are enclosed or embodied in a single housing as a single unit 580. In other implementations, image capture device 28 and portable device holder 550 may be separate components.

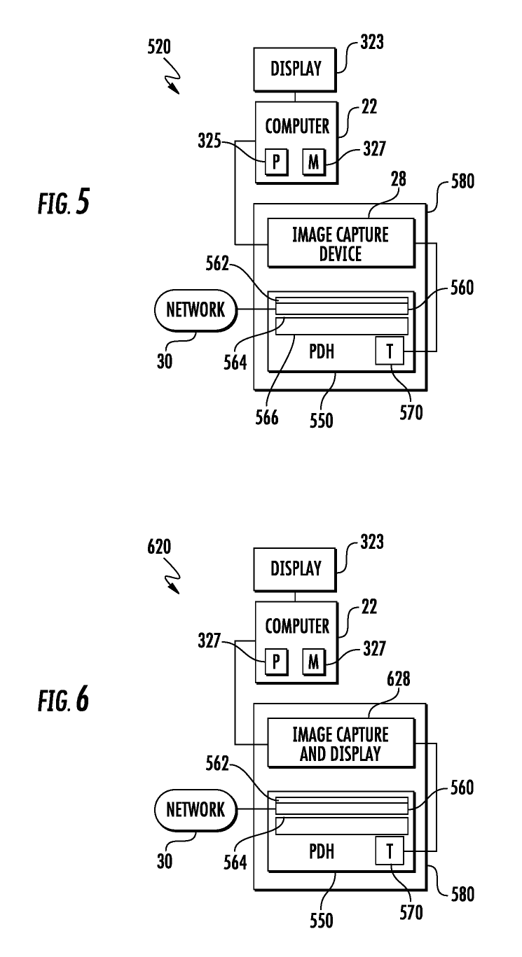

FIG. 6 schematically illustrates non-electronic firewall system 620. System 620 is similar to system 520 except that system 620 comprises image capture and display device 628 in view of image capture device 28. Image capturing display device 628 is configured to both capture an image of the presentation of display screen 562 of device 564 receiving and storing an image that is been received by device 560 across never 30 as well as to display an image supplied by computer 22 for image capture by a camera of the portable electronic device 564 transmission to a recipient across network 30. System 620 allows a person to both receive and send data or information across network 30 without exposing computer 22 to malware, viruses or data security breaches. As indicated by broken lines, in some implementations, device 628 and provides holder 550 may be embodied or enclosed within a single housing to form a single unit or module which may be simply plugged into computer 22 for such insulated and secured data communication.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements.

What is claimed is:

1. A non-electronic firewall system comprising:
a first computer isolated from any network;
a second computer connected to a network;
a first display connected to the second computer to display a first image from the second computer; and
a first image capture device connected to the first computer to capture a second image of a presentation of the display including the first image and to store the second image on the first computer;
a second display connected to the first computer to display a third image from the first computer
a second image capture device connected to the second computer to capture a fourth image of a presentation on the second display including the third image and to transmit the fourth image across the network.

2. The non-electronic firewall system of claim 1, wherein at least one of the image capture device and the second image capture device comprises a flatbed scanner.

3. The non-electronic firewall system of claim 2, wherein the display comprises a flatbed display and wherein one of the flatbed scanner and the flatbed display is horizontally supported opposite the other of the flatbed scanner and the flatbed display.

4. The non-electronic firewall system of claim 3 comprising a single housing enclosing the flatbed scanner and the flatbed display and fixing the flatbed scanner and the flatbed display relative to one another.

5. The non-electronic firewall system of claim 3, wherein one of the flatbed scanner and the flatbed display rests upon the other of the flatbed scanner in the flatbed display.

6. The non-electronic firewall system of claim 3, wherein the first image capture device comprises a sensor to sense the presence of the presentation on the first display and to automatically trigger the capturing of the second image of the presentation on the first display in response to the presence of the presentation on the first display.

7. The non-electronic firewall system of claim 6, wherein the image capture device comprises a second sensor to sense the presence of the second presentation on the second display and to automatically trigger the capturing of the fourth image of the second presentation on the second display in response to the presence of the second presentation on the second display.

8. The non-electronic firewall system of claim 1 comprising a single housing enclosing the first image capture device and the first display and fixing the first image capture device and the first display relative to one another.

9. The non-electronic firewall system of claim 1 comprising a single housing enclosing the image capture device and the display and fixing the image capture device and the display relative to one another.

10. The non-electronic firewall system of claim 1, wherein the image capture device comprises a camera.

11. The non-electronic firewall system of claim 1, wherein the network comprises a wide area network.

12. A non-electronic firewall system comprising:
a computer isolated from any network;
an image capture device connected to the computer; and
a portable device holder to receive and locate a portable electronic device with respect to the image capture device such that the image capture device, when activated, captures a presentation on a display of the portable electronic device.

13. The non-electronic firewall system of claim 12, wherein the portable device holder is configured to receive and locate a smart phone opposite to the image capture device.

14. The non-electronic firewall system of claim 12, wherein the portable device holder comprises a trigger that senses the presence of the portable electronic device on the portable device holder and automatically triggers capturing of an image of a presentation of the portable electronic device by the image capture device in response to the sensed presence of the portable electronic device on the portable device holder.

15. The non-electronic firewall system of claim 14 further comprising a display connected to the computer to present an image sized and located for being captured by a camera of the portable electronic device.

16. A non-electronic firewall system comprising:
a first computer isolated from any network;
a second computer connected to a network;
a display connected to the first computer to display a first image from the first computer;
an image capture device connected to the second computer to capture an image of a presentation on the display including the first image and to transmit the first image across the network.

17. The non-electronic firewall system of claim 16, wherein the display an and the image capture device are fixed relative to one another within a single housing.

18. The non-electronic firewall system of claim 17 further comprising a sensor to sense the display of the first image on the display and to automatically activate the image capture device in response to the sensing of the display of the first image on the display.

19. The non-electronic firewall system of claim 16 further comprising a sensor to sense the display of the first image on the display and to automatically activate the image capture device in response to the sensing of the display of the first image on the display.
